(19) United States
(12) Patent Application Publication
(10) Pub. No.: US 2013/0332044 A1
(43) Pub. Date: Dec. 12, 2013

(54) APPARATUS AND METHOD FOR SPEED CONTROL ON A CURVED ROAD IN A SMART CRUISE CONTROL SYSTEM

(71) Applicants: HYUNDAI MOTOR COMPANY, Seoul (KR); KIA MOTORS CORPORATION, Seoul (KR)

(72) Inventors: Dae Youn Um, Hwaseong (KR); Jee Young Kim, Yongin (KR)

(73) Assignees: KIA MOTORS CORPORATION, Seoul (KR); HYUNDAI MOTOR COMPANY, Seoul (KR)

(21) Appl. No.: 13/715,294

(22) Filed: Dec. 14, 2012

(30) Foreign Application Priority Data
Jun. 12, 2012 (KR) 10-2012-0062805

(51) Int. Cl. B60K 31/00

(52) U.S. Cl. CPC B60K 31/0066
USPC 701/93

(57) ABSTRACT

An apparatus for controlling a speed on a curved road in a smart cruise control system configured to obtain road coordinate information of a front portion of a vehicle from a navigation system based on a current location of the vehicle, calculate a curvature value of the curved road based on the road coordinate information, calculate a speed corresponding to the curvature value, and control a speed setting of the vehicle based on the speed corresponding to the curvature value when approaching the curved road.

### CROSS-REFERENCES TO RELATED APPLICATIONS

This application claims priority to Korean patent application No. 10-2012-0062805 filed on Jun. 12, 2012, the disclosure of which is hereby incorporated in its entirety by reference.

### BACKGROUND OF THE INVENTION

1. Field of the Invention

The present invention relates to an apparatus and a method for speed control on a curved road in a smart cruise control system, and more particularly, to an apparatus and a method for controlling a speed of a vehicle on a curved road according to a safe speed corresponding to a curvature value of the curved road on a front path by calculating the curvature value based on road coordinate information of the curved road of a front portion provided from a navigation.

2. Description of the Related Art

A smart cruise control (“SCC”) system is a system in which, when there exists no vehicle in front, a speed control may be performed at a speed set by a driver and, when there exists a vehicle in front, a distance control is performed to maintain a predetermined distance or more to the vehicle in front, such that the driver may not need to manually manipulate, for example, a break and an accelerator, thereby providing convenience and safety to the driver.

However, the smart cruise control system does not decelerate until a predetermined lateral acceleration occurs even when the vehicle enters into a curved road such as an interchange (IC) and a junction (JC) on a highway while operating the smart cruise control system. Therefore, the driver may not depend on the SCC system because deceleration does not occur when the vehicle enters into the curved road, and thus, the driver must manually manipulate, for example, the break such that the SCC system is terminated Furthermore, once the vehicle reaches a straight road, the SCC setting must be performed again to operate the SCC system.

### SUMMARY OF THE INVENTION

Accordingly, the present invention provides an apparatus and a method for speed control on a curved road in a smart cruise control system, in which road coordinate information of the curved road that is on a front path is received from a navigation while a vehicle is controlled by the smart cruise control system and a speed of the vehicle corresponding to a curvature value calculated based on the received road coordinate information may be calculated such that the speed of the vehicle may be accelerated or decelerated corresponding to the curved road in front.

Additionally, the present invention provides an apparatus and a method for speed control on a curved road in a smart cruise control system in which, with respect to coordinate information provided from a navigation, coordinate information of virtual interpolation points calculated at a predetermined interval in a front portion based on a current location of a vehicle may be used, rather than interpolation points determined based on a map, thereby enabling a substantially fast response to an actual circumstance.

In accordance with one embodiment of the present invention, an apparatus for controlling a speed on a curved road in a smart cruise control system may include a plurality of units executed by a processor within a controller having a memory. The plurality of units may include: a curved road information obtaining unit configured to obtain road coordinate information of a front portion of a vehicle from a navigation system based on a current location of the vehicle when a front path of the vehicle includes the curved road on; a curvature calculation unit configured to calculate a curvature value of the curved road of the front portion of the vehicle based on the road coordinate information obtained by the curvature information obtaining unit; a setting speed calculation unit configured to calculate a speed corresponding to the curvature value calculated with respect to the curved road of the front portion of the vehicle; and a speed unit configured to control a speed setting of the vehicle based on the speed corresponding to the curvature value when approaching the curved road of the front portion of the vehicle. The road coordinate information may include coordinate information corresponding to virtual interpolation points calculated of a preset distance based on the current location of the vehicle. The road coordinate information may include coordinate information corresponding to at least three virtual interpolation points. When a location of the vehicle is changed, the curved road information obtaining unit may obtain the coordinate information of the front portion of the vehicle from the navigation system using the predetermined distance or a predetermined time period until the vehicle travels past the curved road.

According to another embodiment of the present invention, a method of controlling a speed on a curved road in a smart cruise control system may include obtaining, by a processor, road coordinate information of a front portion of a vehicle based on a current location of the vehicle when a front path of the vehicle includes a curved road; calculating, by the processor, a curvature value of the curved road based on the road coordinate information; calculating, by the processor, a speed corresponding to the curvature value calculated with respect to the curved road; and controlling, by the processor, a speed setting of the vehicle based on the speed corresponding to the curvature value when approaching the curved road. The road coordinate information may be coordinate information corresponding to virtual interpolation points calculated of a predetermined distance based on the current location of the vehicle. The road coordinate information may include coordinate information corresponding to at least three virtual interpolation points. Obtaining the road coordinate information may further include: obtaining, by the processor when a location of the vehicle is changed, the road coordinate information of the front portion of the vehicle from the navigation of a predetermined distance or a predetermined time period until the vehicle travels past the curved road.

### BRIEF DESCRIPTION OF THE DRAWINGS

The objects, features and advantages of the present invention will be more apparent from the following description of exemplary embodiments in conjunction with the accompanying drawings, in which:

FIGS. 1 and 2 are exemplary views illustrating a schematic operation of an apparatus for controlling a speed on a curved road in a smart cruise control system according to an exemplary embodiment of the present invention;

FIG. 3 is an exemplary block diagram illustrating a configuration of an apparatus for controlling a speed on a curved road in a smart cruise control system according to an exemplary embodiment of the present invention;

FIG. 4 is an exemplary view illustrating road coordinate information applied to an apparatus for controlling a speed on a curved road in a smart cruise control system according to an exemplary embodiment of the present invention;

FIG. 5 is an exemplary view illustrating a process of calculating a curvature value of an apparatus for controlling a speed on a curved road in a smart cruise control system according to an exemplary embodiment of the present invention;

FIG. 6 is an exemplary view illustrating a processor of calculating a speed of an apparatus for controlling a speed on a curved road in a smart cruise control system according to an exemplary embodiment of the present invention;

FIG. 7 is an exemplary view illustrating a process of updating a speed setting of an apparatus for controlling a speed on a curved road in a smart cruise control system according to an exemplary embodiment of the present invention;

FIG. 8 is an exemplary view illustrating a speed control operation of an apparatus for controlling a speed on a curved road in a smart cruise control system according to an exemplary embodiment of the present invention; and

FIG. 9 is an exemplary flowchart illustrating a method of controlling a speed on a curved road in a smart cruise control system according to an exemplary embodiment of the invention.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

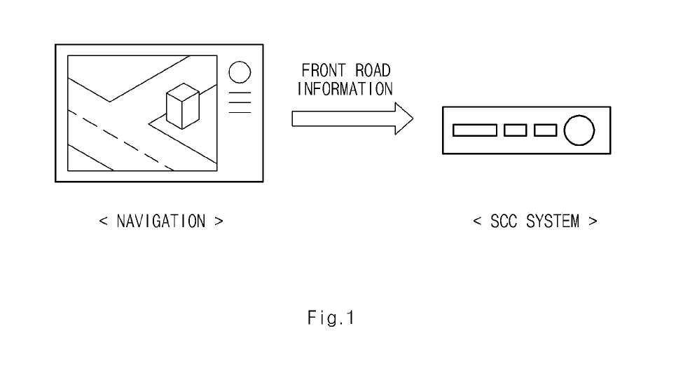

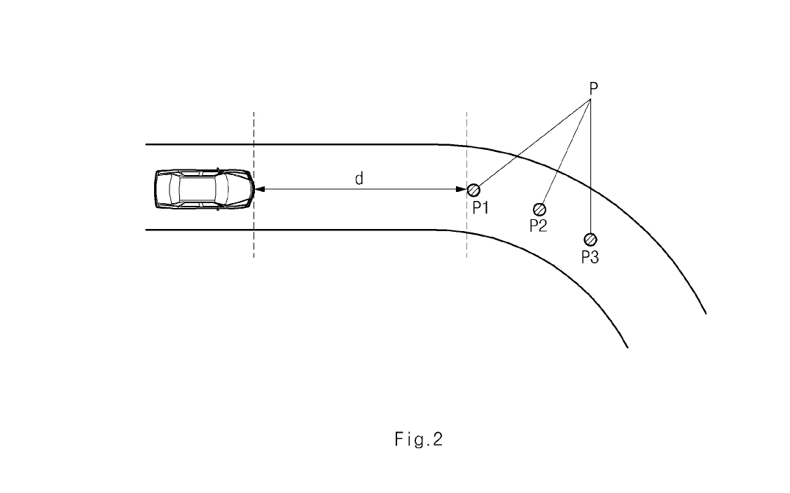

FIGS. 1 and 2 are exemplary views illustrating a schematic operation of an apparatus for controlling a speed on a curved road in a smart cruise control system according to an exemplary embodiment of the present invention.

Illustrated in FIG. 1, is an apparatus for controlling a speed on a curved road in a smart cruise control system (hereinafter, referred to as “curved road speed control apparatus”) according to the invention which may enable a navigation system and the smart cruise control (SCC) system to share front road information such that a vehicle speed may be automatically controlled in response to an approaching curved road in the SCC system.

Moreover, the navigation system disposed within a vehicle may identify an oncoming curved road on a front path of the vehicle based on a preset driving path. When the front path includes the curved road, the navigation system may calculate a plurality of virtual interpolation points within a certain front portion of the vehicle using a predetermined distance and may provide coordinate information corresponding to each virtual interpolation point to the SCC system of a vehicle.

For example, when the front path includes the curved road, as shown in FIG. 2, the navigation system may calculate three virtual interpolation points P1, P2 and P3 of a predetermined distance, e.g., 100 m, past a distance d in front of the vehicle and may provide coordinate information corresponding to each interpolation point P to the SCC system of the vehicle.

Moreover, the navigation system reflects a continuously changing position of the vehicle and may calculate the virtual interpolation points for the front portion of the vehicle of a predetermined distance or a predetermined time period to provide corresponding coordinate information to the SCC system of the corresponding vehicle. Furthermore, the navigation may provide coordinate information for the front portion of the vehicle to the SCC system up to when the vehicle travels past the curved road. Depending on a setting, when a vehicle remains on substantially straight road for a predetermined distance or more, an operation of providing the coordinate information of the curved road may be terminated.

Therefore, the SCC system may calculate a curvature of the curved road based on the road coordinate information for the front portion with respect to a current location of the vehicle, and accordingly, the SCC system may identify a safe speed on the curved road based on the calculated curvature, thereby enabling an automatic speed control without canceling the SCC mode on the curved road.

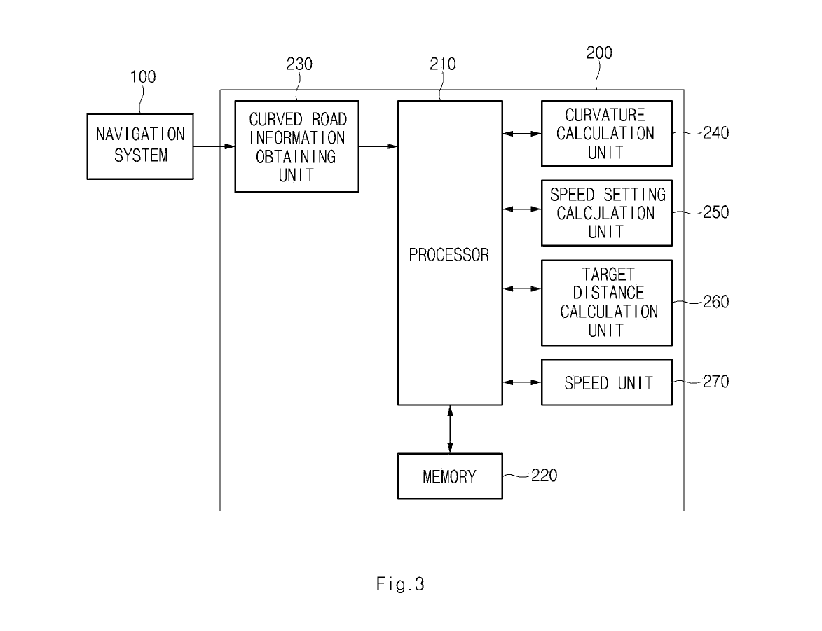

A detailed description of the curved road speed control apparatus according to the invention will be described with reference to FIG. 3.

FIG. 3 is an exemplary block diagram illustrating a configuration of a curved road speed control apparatus in a smart cruise control system according to an exemplary embodiment the present invention.

Referring to FIG. 3, a curved road speed control apparatus 200 according to the present invention may include a plurality of units executed by a processor 210 within a controller a having a memory 220. The plurality of units may include a curved road information obtaining unit 230, a curvature calculation unit 240, a speed setting calculation unit 250, a target distance calculation unit 260, and a speed unit 270. Here, the processor 210 may control an operation of each unit of the curved road speed control apparatus 200.

The processor may store on the memory 220, for example, a setting value for operating the curved road speed control apparatus and may store the road coordinate information obtained from the navigation system and a resulting data calculated by the curved road speed control apparatus corresponding to the road coordinate information.

When the front path of the vehicle includes a curved road, the curved road information obtaining unit 230 may obtain, by the processor, from the navigation system 100, the road coordinate information for the front portion of the vehicle with respect to the current location of the vehicle.

Moreover, the road coordinate information obtained from the navigation system 100 may be coordinate information corresponding to a plurality of virtual interpolation points calculated using a predetermined distance with respect to the current location of the vehicle. Furthermore, the road coordinate information may include coordinate information corresponding to at least three virtual interpolation points.

Additionally, the curved road information obtaining unit 230 may obtain, by the processor, from the navigation system 100, the road coordinate information for the front portion of the vehicle of a predetermined distance or a predetermined time period until the vehicle travels past the curved road. Specifically, depending on the setting, the curved road information obtaining unit 230 may obtain, by the processor, the road coordinate information from the navigation system 100 for the front portion of the vehicle up until when the vehicle remains on a substantially straight road for a certain period of time.

The curvature calculation unit 240 may calculate, by the processor, a curvature value of the curved road based on the road coordinate information obtained by the curved road information obtaining unit 230. The curvature value calculated by the curvature calculation unit 240 may be a radius of curvature. Moreover, the curvature calculation unit 240 may calculate, by the processor, a curvature value of a corresponding point by using coordinate information of at least three virtual interpolation points. In particular, the curvature calculation unit 240 may calculate, by the processor, a curvature value of a middle point of the three virtual interpolation points.

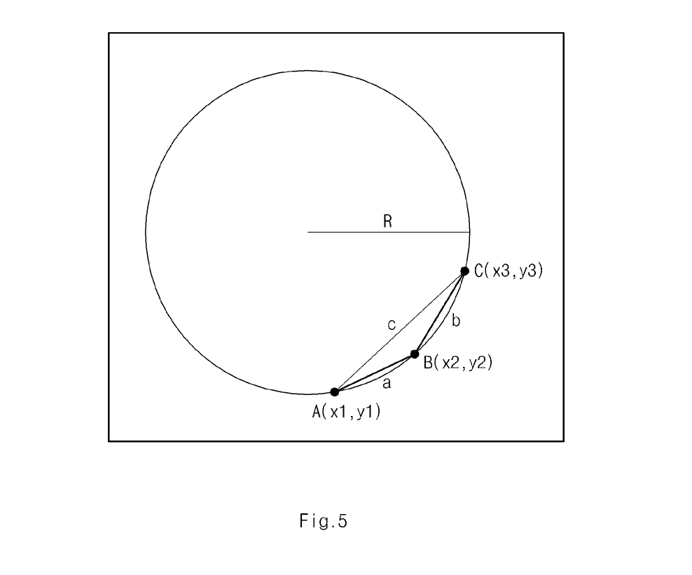

Furthermore, when the vehicle changes a location, the curvature calculation unit 240 may calculate, by the processor, a curvature value of a subsequent point by using coordinate information that may be subsequently input. A detailed exemplary embodiment of an operation of calculating the curvature value by using the road coordinate information obtained from the navigation 100 will be described with reference to FIG. 5.

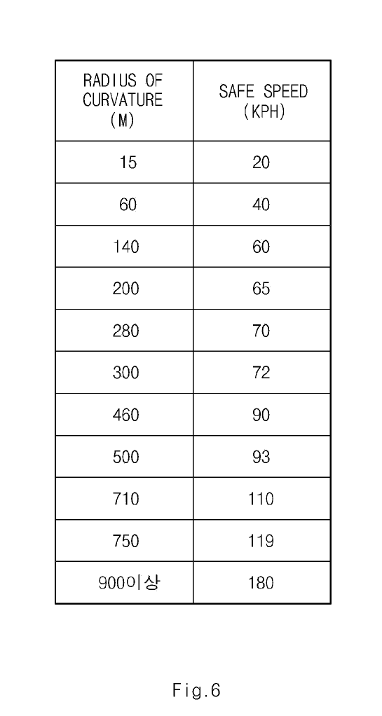

The speed setting calculation unit 250 may calculate, by the processor, a speed corresponding to the curvature value calculated by the curvature calculation unit 240 with respect to the curved road. Furthermore, the speed setting calculation unit 250 may calculate, by the processor, a speed corresponding to the curvature value calculated by the curvature calculation unit 240 based on a lookup table in which speed information corresponding to curvature values may be recorded. An exemplary embodiment of the lookup table will be described with reference to FIG. 6.

The target distance calculation unit 260 may calculate, by the processor, a target distance (e.g., a distance remaining up to a target destination) according to a location change of the vehicle based on each point of which curvature is calculated among road coordinate information obtained by the curved road information obtaining unit 230. For example, with respect to a particular point of which curvature value is calculated, the target distance calculation unit 260 may calculate, by the processor, a distance remaining up to a corresponding point according to the location change of the vehicle.

The speed unit 270 may monitor, by the processor, a distance remaining up to the target destination according to the location change of the vehicle calculated by the target distance calculation unit 260 and, when the vehicle reaches the target destination, the speed setting of the vehicle may be controlled such that the vehicle may be driven at a speed calculated by the speed setting calculation unit 250.

As example, when a current driving speed of the vehicle is about 110 kilometers per hour (kph) and a speed corresponding to the curvature value of the oncoming curved road that is about 700 meter (m) away is about 60 kph, the speed unit 270 may control a deceleration of the vehicle from a 500 m point in front such that the vehicle is driven at 60 kph in a 700 m point in front. It should be noted that a process for calculating a required acceleration of the vehicle may be provided to this end; however, a description thereof will be omitted.

The present invention may be configured to include the speed unit 270 for controlling the sped setting of the vehicle based on the speed information corresponding to the curvature value when the vehicle approaches the curved road.

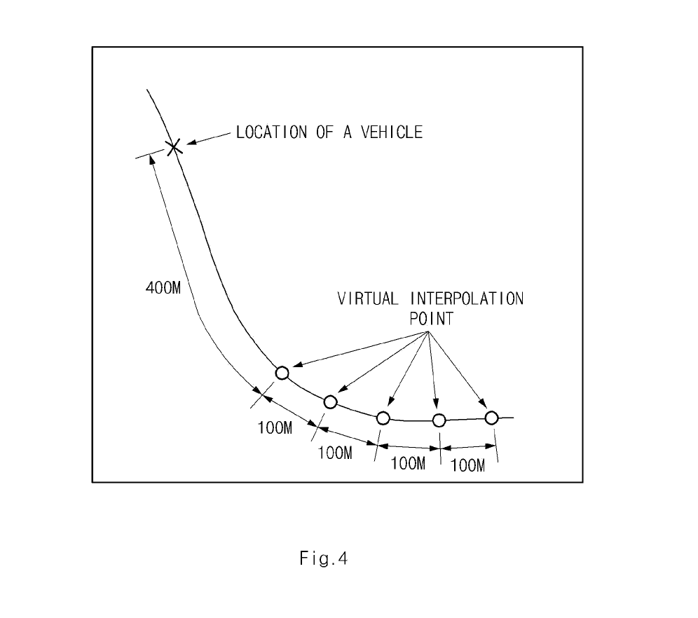

FIG. 4 is an exemplary view illustrating road coordinate information that applies to a curved road speed control apparatus in a smart cruise control system according to an exemplary embodiment of the present invention.

Illustrated in FIG. 4, is the curved road speed control apparatus according to the present invention, including the navigation system of the vehicle, with coordinate information of the virtual interpolation points calculated for the front portion of the vehicle.

Moreover, the virtual interpolation point may be calculated using a predetermined distance within a corresponding portion by calculating a preset distance and portion based on the current location of the vehicle.

For example, the navigation system may calculate three virtual interpolation points from a 400 m point in front of the vehicle using a predetermined distance of 100 m distance, i.e., 400 m, 500 m, and 600 m, and may provide corresponding coordinate information to the curved road speed control apparatus. Additionally, when the vehicle travels by 100 m, the navigation system may calculate three virtual interpolation points of 100 m from the 400 m point in front of the vehicle from a new location to which the vehicle is moved and may provide corresponding coordinate information to the curved road speed control apparatus.

Thus, the navigation system may calculate the virtual interpolation point of a set interval when the vehicle travels past the 100 m and may provide corresponding coordinate information to the curved road speed control apparatus. It should be noted that a reference distance for providing the coordinate information is not limited to one and is changeable according to the setting. Moreover, the coordinate information may be provided based on, for example, time.

Therefore, the curved road speed control apparatus may calculate, by the processor, the curvature value of the curved road based on the coordinate information of the virtual interpolation points. Furthermore, the curved road speed control apparatus may receive, by the processor, coordinate information corresponding to at least three virtual interpolation points to calculate the curvature value of the curved road by using the virtual interpolation points.

FIG. 5 is an exemplary view illustrating an operation of calculating a curvature value of a curved road speed control apparatus in a smart cruise control system according to an exemplary embodiment of the present invention.

Referring to FIG. 5, when coordinates corresponding to three virtual interpolation points obtained by the curved road speed control apparatus from the navigation are A(x1, y1), B(x2, y2), and C(x3, y3), the curved road speed control apparatus may obtain a radius R of a circle that includes the three points A, B and C by using the three coordinates A(x1, y1), B(x2, y2), and C(x3, y3), and the obtained radius R may be the radius of curvature.

However, a radius of curvature calculated by using there coordinates A(x1, y1), B(x2, y2), and C(x3, y3) may be a radius of curvature of B(x2, y2) that is a median coordinate of the three coordinates.

Therefore, after the vehicle changes a location and coordinates B(x2, y2), C(x3, y3) and D(x4, y4) are obtained, the curved road speed control apparatus may calculate a radius of curvature with respect to C(x3, y3), a median coordinate, by using the obtained three coordinates B(x2, y2), C(x3, y3) and D(x4, y4).

Thus, the curved road speed control apparatus may calculate, by the processor, a radius of curvature of the virtual interpolation points with respect to the curved road in front of the vehicle through coordinate information input from the navigation system according to the location change of the vehicle.

FIG. 6 is an exemplary view illustrating an operation of calculating a speed of a curved road speed control apparatus in a smart cruise control system according to an exemplary embodiment of the present invention.

Since the curved road may have a substantially increased degree of curvature as a radius of curvature decreases, the vehicle speed may be substantially decreased as the radius of curvature decreases. Alternatively, the curved road may become substantially straighter as a radius of curvature increases and the vehicle speed may be increased. Accordingly, a safe driving speed of the vehicle corresponding to each radius of curvature may be recorded in the lookup table and the curved road speed control apparatus may calculate, by the processor, a speed corresponding to the radius of curvature by using the lookup table.

As shown in FIG. 6, the safe speed corresponding to the radius of curvature may be as follows: 20 kph for 15 m of a radius of curvature, 40 kph for 60 m of a radius of curvature, 60 kph for 140 m of a radius of curvature, 65 kph for 200 m of a radius of curvature, 80 kph for 280 m of a radius of curvature, 72 kph for 300 m of a radius of curvature, 90 kph for 460 m of a radius of curvature, 93 kph for 500 m of a radius of curvature, 110 kph for 710 m of a radius of curvature, 119 kph for 750 m of a radius of curvature, 180 kph for 800 m or greater of a radius of curvature.

It should be noted that the lookup table shown in FIG. 6 is merely an exemplary embodiment and may be changed according to a driving pattern or a manual setting of the driver.

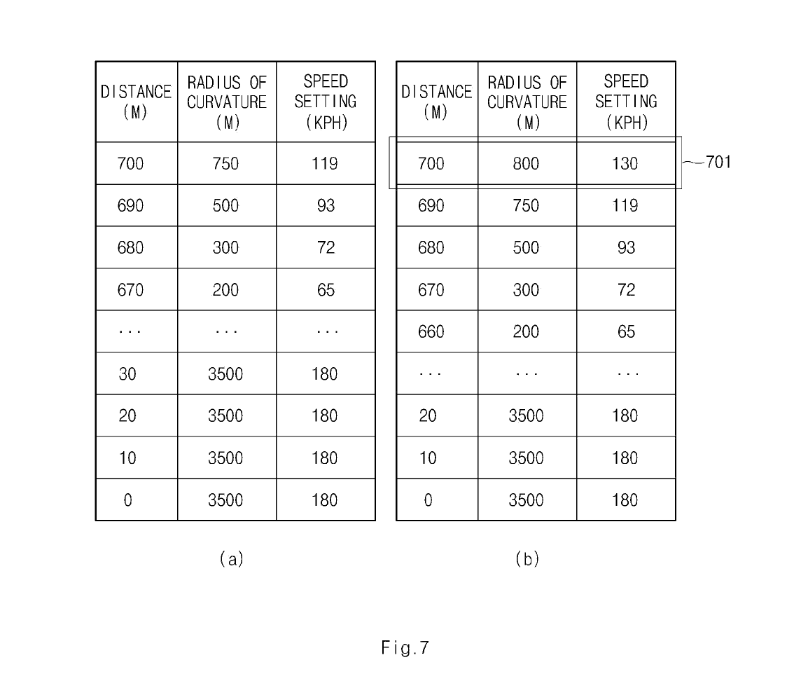

FIG. 7 is an exemplary view illustrating an operation of updating a speed setting of a curved road speed control apparatus in a smart cruise control system according to an exemplary embodiment of the present invention.

In an exemplary embodiment of FIG. 7, coordinate information having a 10 m interval with respect to the front portion of the vehicle may be received, by the processor, from the navigation system whenever the vehicle changes a location by 10 m and may calculate a curvature of a corresponding point and a corresponding speed setting.

In other words, according to the driving table obtained at a particular location shown in (a) of FIG. 7, a radius of curvature may be 200 m at a 670 m point away from a current location of the vehicle and a speed setting may be 65 kph calculated based on the lookup table, and a radius of curvature may be 300 m at a 680 m point away from a current location of the vehicle and a speed setting may be 72 kph calculated based on the lookup table. Also, a radius of curvature may be 500 m at a 690 m point away from a current location of the vehicle and a speed setting may be 93 kph calculated based on the lookup table, and a radius of curvature is 750 m at a 700 m point away from a current location of the vehicle and a speed setting may be 119 kph calculated based on the lookup table.

Further, when the vehicle changes location by 10 m, the radius of curvature and the speed setting according to a driving distance shown in (a) of FIG. 7, may be updated as shown in (b) of FIG. 7.

In other words, when the vehicle changes location by 10 m, a distance, (e.g., the target distance) up to a point corresponding to data recorded as shown in (a) of FIG. 7 may be decreased by 10 m. In addition, the coordinate information with respect to the=front portion of the vehicle may be obtained from the navigation system with respect to a point forwarded by 10 m from the navigation system and the curved road speed control apparatus may calculate, by the processor, a curvature of a point that is 700 m away from a point to which the vehicle may have moved and a corresponding speed setting.

Therefore, a newly obtained data 701, based on the current location of the vehicle which changes a location, (e.g., a radius of curvature) of 800 m at a point 700 m of the target distance and a corresponding speed setting 130 kph may be updated to the driving table.

When the curvature and the speed setting are continuously updated with respect to the front portion of the vehicle, the curved road speed control apparatus may initiate the smart cruise control to control the vehicle based on the speed setting recorded in a corresponding table.

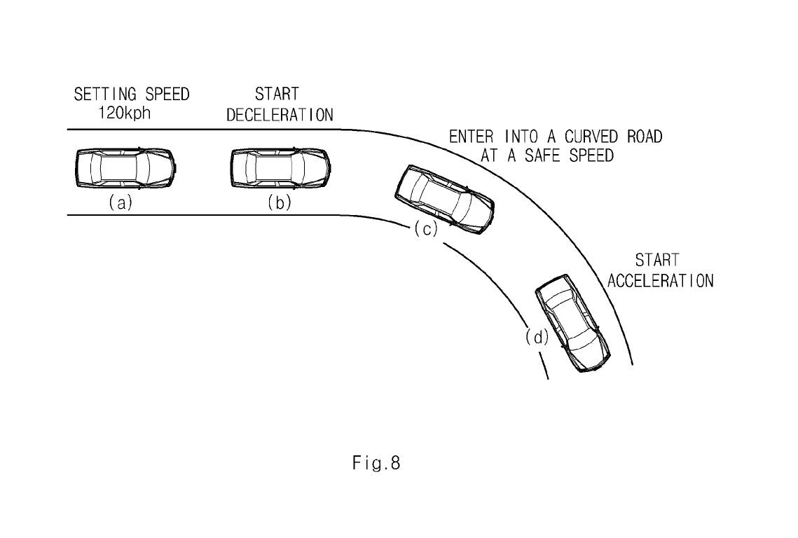

FIG. 8 is an exemplary view illustrating a speed control operation of a curved road speed control apparatus in a smart cruise control system according to an exemplary embodiment of the present invention.

Referring to FIG. 8, the curved road speed control apparatus according to the present invention may control, by the processor, a vehicle speed based on the driving table of FIG. 7.

In other words, based on the driving table, the curved road speed control apparatus may be driven at 120 kph according to an existing speed setting at point (a). Moreover, when the vehicle reaches point (b), the curved road speed control apparatus may begin decelerating according to an acceleration requirement calculated previously to maintain the safe speed at point (c), i.e., on the curved road. Therefore, the vehicle may begin decelerating at the point (b) and, when the vehicle reaches the point (c), the vehicle may travel the curved road at the safe speed corresponding to a curvature calculated beforehand.

Furthermore, when the vehicle reaches point (d), i.e., an ending point of the curved road, the curved road speed control apparatus may begin accelerating to drive the vehicle at a speed initially set for the straight road. Additionally, the SCC system may distinguish a general driving mode and a curved road driving mode such that the vehicle may be driven in the curved road driving mode only when the front path includes the curved road or may operate according to the curvature value detected in the front portion of the vehicle without distinguishing modes, and an exemplary embodiment for performing this is not limited to one.

A method of the curved speed control apparatus of the smart cruise control system having the above configuration according to the invention is described in more detail as below.

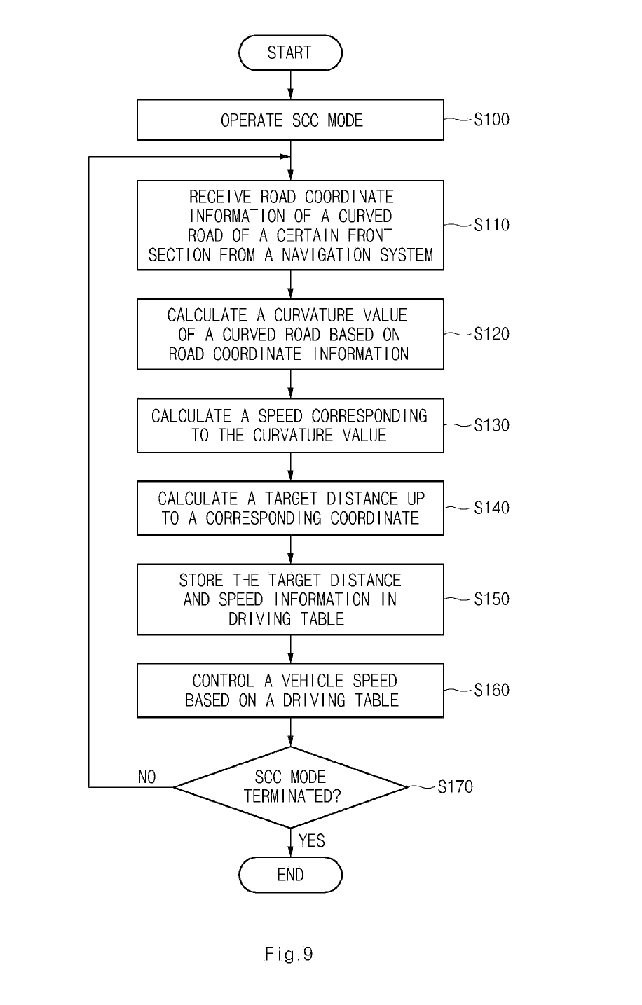

FIG. 9 is an exemplary flowchart illustrating a speed control method on a curved road in a smart cruise control system according to the invention.

Referring to FIG. 9, when the curved road speed control apparatus according to the present invention is operated, by a processor, in the SCC mode (S100), the road coordinate information of the curved road in a front portion of the vehicle may be received from the navigation system (S110). The road coordinate information received in step S110 may be coordinate information corresponding to virtual interpolation values calculated using a preset distance based on the current location of the vehicle. Additionally, the road coordinate information may include coordinate information corresponding to at least three virtual interpolation points. Furthermore, step S110 may be performed, by the processor, continuously while the vehicle is operated in the SCC mode or performed only when a front path of the vehicle includes the curved road.

Further, the curved road speed control apparatus may calculate, by the processor, the curvature value of the curved road based on the road coordinate information received in step S110 (S120). The curvature value of step S120 may be a curvature value of a specific point on the curved road. For example, when the coordinate information of three virtual interpolation points is received, the curvature value may correspond to the curvature value of a virtual interpolation point at an intermediate position. Here, the curvature value may be a radius of curvature.

The curved road speed control apparatus may calculate, by the processor, a speed in accordance with a corresponding curvature value by using the curvature value calculated in step S120 (S130). In step S130, the speed corresponding to the curvature value may be extracted based on the lookup table in which speed information corresponding to predetermined curvature values may be recorded.

Additionally, the curved road speed control apparatus may calculate, by the processor, the target distance up to the coordinate input in step S110 according to a location change of the vehicle (S140) and may store the curvature value and the speed calculated in steps S120 and S130 into the driving table in response to the target distance calculated in step S140 (S150). Therefore, the curved road speed control apparatus may control, by the processor, a driving speed of the vehicle based on the driving table of step S150 (S160).

Steps S110 through S160 may be repeatedly performed until the SCC mode is terminated, and when the SCC mode is terminated (S170), a corresponding operation may be terminated.

According to the present invention, the road coordinate information of the curved road on the front path may be received from the navigation system while the vehicle is driven by the smart cruise control system to calculate a vehicle speed corresponding to a curvature value calculated based on the received coordinate information such that the vehicle speed may be accelerated or decelerated in advance in response to the oncoming curved road.

Additionally, in the present invention, with respect to the coordinate information provided from the navigation system, the interpolation points may be determined based on the current location of the vehicle, thereby enabling a fast response to an actual circumstance.

In the above, although the embodiments of the present invention have been described with reference to the accompanying drawings, a person skilled in the art should understand that the present invention may be embodied in other specific forms without departing from the technical spirit or essential characteristics thereof. Thus, the embodiments described above should be construed as exemplary in every aspect and not limiting.

What is claimed is:

1. An apparatus for controlling a speed on a curved road in a smart cruise control system, the apparatus comprising:
a processor configured to:
obtain road coordinate information of a front portion of a vehicle from a navigation system based on a current location of the vehicle when a front path of the vehicle includes the curved road;
calculate a curvature value of the curved road based on the road coordinate information;
calculate a speed corresponding to the curvature value; and
control a speed setting of the vehicle based on the speed corresponding to the curvature value when approaching the curved road.

2. The apparatus of claim 1, wherein the road coordinate information is coordinate information corresponding to a plurality of virtual interpolation points calculated using a preset distance based on the current location of the vehicle.

3. The apparatus of claim 2, wherein the road coordinate information includes coordinate information corresponding to at least three virtual interpolation points.

4. The apparatus of claim 1, wherein, in response to a change in a location of the vehicle, the processor is further configured to obtain the coordinate information of the front portion of the vehicle from the navigation system using a predetermined distance or a predetermined time period until the vehicle passes the curved road.

5. A method of controlling a speed on a curved road in a smart cruise control system, the method comprising:
obtaining, by a processor, road coordinate information of a front portion of a vehicle based on a current location of the vehicle when a front path of the vehicle includes the curved road;
calculating, by the processor, a curvature value of the curved road based on the road coordinate information;
calculating, by the processor, a speed setting corresponding to the curvature value; and
controlling, by the processor, a speed setting of the vehicle based on a speed corresponding to the curvature value when approaching the curved road.

6. The method of claim 5, wherein the road coordinate information is coordinate information corresponding to a plurality of virtual interpolation points calculated using a predetermined distance based on the current location of the vehicle.

7. The method of claim 6, wherein the road coordinate information includes coordinate information corresponding to at least three virtual interpolation points.

8. The method of claim 5, wherein obtaining, by the processor, the road coordinate information further comprises:
in response to a location change of the vehicle, obtaining, by the processor, the road coordinate information of the front portion of the vehicle from the navigation system using a predetermined distance or a predetermined time period until the vehicle passes the curved road.

9. A non-transitory computer readable medium containing program instructions executed by a processor or controller, the computer readable medium comprising:
program instructs that obtain road coordinate information of a front portion of a vehicle from a navigation system based on a current location of the vehicle when a front path of the vehicle includes the curved road;
program instructs that calculate a curvature value of the curved road based on the road coordinate information;
program instructs that calculate a speed corresponding to the curvature value; and
program instructs that control a speed setting of the vehicle based on the speed corresponding to the curvature value when approaching the curved road.

10. The computer readable medium of claim 9, wherein the road coordinate information is coordinate information corresponding to a plurality of virtual interpolation points calculated using a preset distance based on the current location of the vehicle.

11. The computer readable medium of claim 10, wherein the road coordinate information includes coordinate information corresponding to at least three virtual interpolation points.

12. The computer readable medium of claim 9, further comprising program instructions that in response to a change in a location of the vehicle, obtain the coordinate information of the front portion of the vehicle from the navigation system using a predetermined distance or a predetermined time period until the vehicle passes the curved road.
